(19) United States
(12) Patent Application Publication
(10) Pub. No.: US 2007/0116890 A1
(43) Pub. Date: May 24, 2007

(54) Method for coating turbine engine components with rhenium alloys using high velocity-low temperature spray process

(75) Inventors: Robbie J. Adams, Phoenix, AZ (US); Margaret M. Floyd, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/285,044

(22) Filed: Nov. 21, 2005

(51) Int. Cl. H05H 1/24

(52) U.S. Cl. 427/569; 427/372.2; 427/402

(57) ABSTRACT

A method of forming a wear-resistant coating on a substrate surface includes the step of cold gas-dynamic spraying a material comprising a rhenium-based composition onto the substrate surface. A metal layer may be formed on the substrate surface prior to the cold gas-dynamic spraying step, and a heat treatment may be performed after the gold gas-dynamic spraying step.

### TECHNICAL FIELD

The present invention relates to methods for applying dense and highly uniform refractory metal alloy coatings onto articles such as aerospace components and, more particularly, to methods for coating at temperatures below the melting points of such alloys.

### BACKGROUND

The aerospace industry is continuously seeking to increase the operating temperatures for launch vehicle components and equipment and/or for aircraft engines and auxiliary equipment, and to thereby enhance the performance and increase the operational life for such products. Since component wear and degradation is problematic, particularly at high temperatures, one approach toward improving heat resistance for aerospace components is to add wear-resistant coatings to their surfaces. However, there is a trade off between increased operational life and the expenses associated with applying the wear-resistant coatings. Iron and nickel-based alloys are just some conventional base materials that benefit from wear-resistant coatings, but adding such coatings substantially increases the cost of manufacturing the components.

One class of materials that has excellent wear rates includes refractory metals such as rhenium and rhenium alloys. Many refractory metals and their alloys are wear-resistant, making them suitable candidates for thin wear-resistant coatings rather than as base coatings. However, refractory materials are typically not only expensive, but require costly processes to apply.

Further, even though such materials have the requisite high temperature strength and/or wear properties to form suitable wear-resistant coatings, their melting temperatures are so much higher than that of the substrates being coated that the refractory metals are difficult to apply using conventional application methods. Thermal spraying treatments such as high velocity oxygen fuel (HVOF) spraying and thermal plasma spraying frequently involve raising the spraying material to its melting temperature to enable bonding and diffusion between the substrate and the spraying material. However, a large differential between the melting temperatures for the substrate and the spraying material may cause thermal spraying processes to be impractical because the melted spraying material may deform or otherwise damage the substrate. For example, rhenium melts at 3172° C., and typical powder metallurgy consolidation including pure rhenium occurs at temperatures of at least 1800°C. and from about 1360 to about 2040 atm. Since many steel alloys melt near or below 1480° C., and many nickel alloys melt near or below 1370° C., conventional thermal spraying and other powder metallurgy techniques are not suitable for forming and consolidating coatings of rhenium or similar refractory metals and alloys on steel or nickel-based alloys. Another reason that conventional thermal spraying may not be suitable is because refractory metals are known to oxidize under these processing conditions altering both the chemical and physical characteristics of the coating.

Hence, there is a need for a method that efficiently and cost-effectively produces a wear-resistant coating from high temperature refractory alloy and superalloy materials that have high strength or hardness. More particularly, a need exists for producing such coatings that are sufficiently thin to be effective yet lightweight. There is also a need for a spraying method by which such materials can be uniformly and thoroughly applied at temperatures well below their melting points.

### BRIEF SUMMARY

The present invention provides a method of forming a wear-resistant coating on a substrate surface. The method includes the step of cold gas-dynamic spraying a material comprising a rhenium-based composition onto the substrate surface. A metal layer may be formed on the substrate surface prior to the cold gas-dynamic spraying step, and a heat treatment may be performed after the gold gas-dynamic spraying step.

Other independent features and advantages of the preferred methods will become apparent from the following detailed description, taken in conjunction with the accompanying drawing which illustrates, by way of example, the principles of the invention.

### BRIEF DESCRIPTION OF THE DRAWING

FIG. 1 is a schematic view of a cold spraying apparatus;

FIG. 2 is a cross-sectional view of a workpiece having a wear-resistant coating formed thereon using a cold spraying process; and

FIG. 3 is a flow chart depicting an exemplary method for forming a wear-resistant coating on a substrate.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

Cold gas-dynamic spraying (hereinafter “cold spraying”) is a technique that is sometimes employed to form coatings of various powdered materials on a substrate. In general, a cold spraying system uses a pressurized carrier gas to accelerate particles through a supersonic nozzle and toward a targeted surface. The cold spraying process is referred to as a “cold gas” process because the particles are mixed and sprayed at a temperature that is well below their melting point, and the particles are near ambient temperature when they impact with the targeted surface. Converted kinetic energy, rather than a high particle temperature, causes the particles to plastically deform, which in turn causes the particles to form a mechanical bond with the targeted surface. Bonding to the component surface occurs as a solid state process with insufficient thermal energy to transition the solid powders to molten droplets. Cold spraying techniques can therefore produce a wear or corrosion-resistant coating that strengthens and protects the component using a variety of materials that can not be applied using techniques that expose the materials and coatings to high temperatures.

A variety of different systems and implementations can be used to perform a cold spraying process. For example, U.S. Pat. No. 5,302,414, entitled “Gas-Dynamic Spraying Method for Applying a Coating” describes an apparatus designed to accelerate to supersonic speed materials having a particle size of between 5 to about 50 microns. The particles are sprayed from a nozzle at a velocity ranging between 300 and 1200 m/s. Heat is applied to the carrier gas to between about 300 and about 400° C., but expansion in the nozzle causes the spraying material to cool. The spraying material therefore returns to near ambient temperature by the time it reaches the targeted substrate surface.

When the sprayed particles impinge on the targeted substrate surface, the impact breaks up any oxide films on the particle and substrate surfaces as the particles bond to the substrate. Thus, cold spraying techniques prevent unwanted oxidation of the substrate or powder, and thereby produce a cleaner coating than many other processes. Such techniques also enable the formation of non-equilibrium coatings. More specifically, since the sprayed materials are not heated or otherwise caused to react with each other or with the substrate, coatings can be produced that are not producible using other techniques.

In contrast to cold spraying, thermal spraying processes include heating methods to bring at least some of the spray material to a melting point, thereby producing a strong and uniform coating. Some thermal spraying processes also utilize a plasma to ionize the sprayed materials or to assist in changing the sprayed materials from solid phase to liquid or gas phase. Melted spraying particles produce liquid splats that land on a targeted substrate surface and bond thereto. Some thermal spraying techniques only supply sufficient heat to melt a fraction of the spraying material particles, and consequently only cause surface melting to occur.

As previously discussed, thermal spraying is not a viable method for applying coatings of alloys having relatively high melting temperatures to many substrates since the high temperature liquid or particles may react with or disrupt the substrate surface and perhaps lower its strength. Cold spraying is sometimes a preferred spraying method because it enables the sprayed materials to bond with a substrate at a relatively low temperature, and to form coatings of unique alloys that are not formable using thermal spraying techniques. The coating materials that are sprayed using the cold gas-dynamic spraying process typically only incur a net gain of about 100° C. with respect to the ambient temperature. Plastic deformation facilitates mechanical bonding of sprayed particles to the substrate. Consequently, metallurgical reactions between the sprayed powder and the component surface are minimized. Further, since the sprayed particles are kept well below their melting temperatures, they are not very susceptible to oxidation or other reactions.

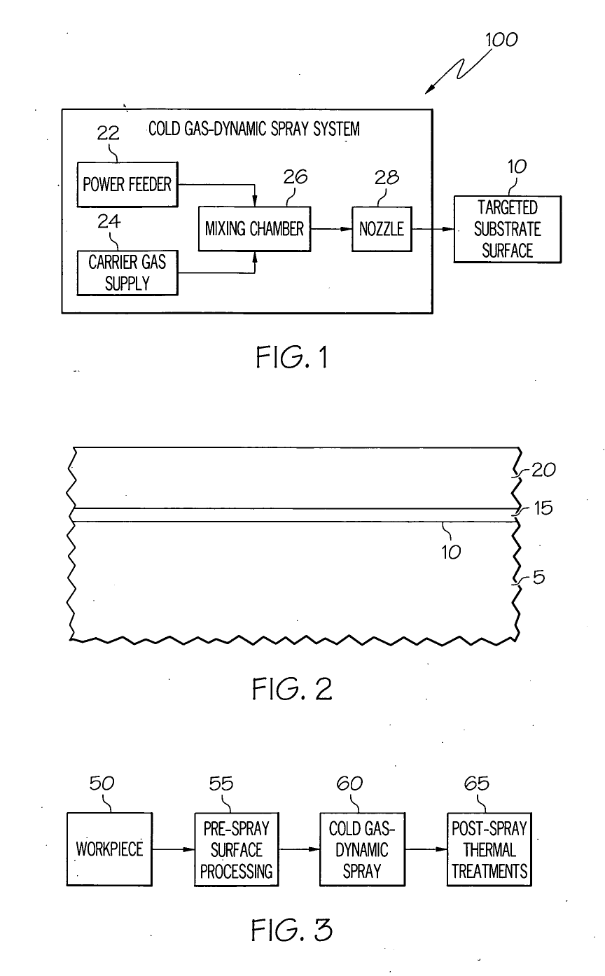

Turning now to FIG. 1, an exemplary cold spraying system 100 is illustrated diagrammatically. The system 100 is illustrated as a general scheme, and additional features and components can be implemented into the system 100 as necessary. The main components of the cold spraying system 100 include a powder feeder 22 for providing powder materials, a carrier gas supply 24 for heating and accelerating powder materials at temperatures of about 300 to 400° C., a mixing chamber 26 and a convergent-divergent nozzle 28. In general, the system 100 transports the metal powder mixtures with a suitable pressurized gas to the mixing chamber 26. The particles are accelerated by the pressurized carrier gas such as air, helium or nitrogen, through the specially designed supersonic nozzle 28 and directed toward a targeted surface 10 to form a dense and uniform coating.

According to an exemplary cold spraying method, one or more refractory materials that have high melting temperatures are cold sprayed onto a substrate to form a wear-resistant coating. Rhenium alloys and superalloys are preferred refractory materials for forming such coatings due in part to the exceptional wear rates for coatings formed from such materials. Further, the combination of the wear-resistant coating with a less expensive substrate such as iron or nickel-based substrates with a thin but highly wear-resistant coating provides a relatively inexpensive component having an extended operational life. Other substrates that may advantageously be coated with the wear-resistant coating include cobalt, molybdenum, tungsten, chromium, and magnesium-based alloys.

Some exemplary rhenium alloys and rhenium-based materials include elements and/or compounds that have substantially lower melting temperatures than rhenium, but have full or partial solubilities with rhenium. Cobalt, nickel, chromium, and manganese are some elements that have low melting temperatures and partial to high solubility with rhenium. Additional refractory materials such as silicon carbide may also be included in the alloy, either as reacted alloy components, separate components, or as particles coated by the rhenium-based alloy. These elements and materials enhance consolidation of rhenium particles, most likely by enhancing the deformability of the alloy as a whole upon impact with a substrate during the cold spraying process. Further, these and other low melting temperature elements enhance diffusion at the substrate/particle interface during any post-spray thermal processes such as annealing, sintering, or other annealing steps.

In addition to silicon carbide, other ceramics, glass, metals and related materials may be mixed with the rhenium-based alloy spraying powder. Some exemplary additional materials include alumina, alumina titanate, aluminum nitride, beryllium oxide, boron nitride, silicon nitride, cobalt oxide, diamond, entatite, fosterite, tungsten carbide, nickel oxide, niobium carbide, silica, zirconia, silicon carbide, tantalum carbide, tantalum niobium carbide, titanium carbide, titanium nitride, titanium carbonitride, titanium diboride, tungsten, tungsten disulfide, tungsten sulfide, and tungsten titanium carbide.

Rhenium alloys that may be cold sprayed to form a wear-resistant coating include rhenium as the most abundant element in terms of atomic percent percent, and preferably include at least about 50% rhenium. An example of such an alloy includes, in terms of atomic percent, about 50% rhenium, 20% cobalt, 15% chromium, 10% nickel, and 5% manganese. Also, ceramic particles that are encapsulated in a rhenium alloy may be cold sprayed to form a wear-resistant coating. An exemplary coated material includes, in terms of atomic percent, silicon carbide particles at about 15% of the total material. The silicon carbide particles are encapsulated in an alloy that includes, in terms of the total material atomic percent, about 50% rhenium, 10% cobalt, 10% nickel, 10% chromium, and 5% manganese. As previously discussed, these are just a couple of examples of materials and alloys that may be cold sprayed on an iron or nickel-based substrate, or various other relatively low melting point substrates, to form a wear-resistant coating.

Turning now to FIG. 3, an exemplary method for forming a wear-resistant coating is outlined in a flow diagram. First, a workpiece is selected as step 50 based on a need for a wear-resistant coating on a workpiece surface. FIG. 2 is a cross-sectional view of a workpiece 5 having a surface 10 coated with a wear-resistant coating 20. An exemplary workpiece 5 is an aerospace engine component such as a face seal, although there are numerous workpieces in various technologies that would benefit from a wear-resistant coating applied using the method outlined in FIG. 3. Iron-based alloys and superalloys including steel, and preferably stainless steel alloys, are ideal substrates for receiving a wear-resistant coating, as are substrates formed from nickel-based alloys and superalloys.

After selecting a suitable workpiece, the targeted workpiece surface 10 is prepared for receiving a wear-resistant coating as step 55 in the method. For example, preparing a workpiece surface may involve surface rebuilding steps, pre-machining, degreasing, and grit blasting the surface 10 in order to remove any oxidation or contamination. Pre-spraying surface processing may further include forming an intermediate layer 15 on the workpiece surface 10. The intermediate layer may be applied by a conventional technique such as electroplating, or by a cold spraying process, and is formed from using a material that is soluble with both the alloy forming the workpiece surface and the material that will form the wear-resistant coating 20. For example, if a rhenium-based wear-resistant coating is to be formed on a steel substrate, one exemplary intermediate layer would be formed from nickel, since nickel is soluble with both rhenium and steel. Depending on the wear-resistant coating and workpiece materials, other suitable materials for forming the intermediate layer may include one or more different elements such as chromium, cobalt, zirconium, vanadium, titanium, tantalum, silicon, scandium, rhodium, platinum, palladium, osmium, columbium, molybdenum, manganese, iridium, hafnium, iron, chromium, beryllium, and boron.

Upon preparing the workpiece surface, the wear-resistant coating 20 is formed by cold spraying a refractory material as step 60 onto the workpiece surface 10 and/or the intermediate layer 15 if present. As previously discussed, during a cold gas spraying process particles at a temperature below their melting temperature are accelerated and directed to the targeted surface 10. When the particles strike the targeted surface 10, the particle kinetic energy causes the particle to plastically deform and form a mechanical bond with the targeted surface 10. Any of the previous-discussed refractory materials or mechanical mixtures may be used, although rhenium-based alloys and superalloys are preferred. The spraying step 60 forms the wear-resistant coating 20 and generally maintains the component's desired dimensions, although additional machining can be performed if necessary to accomplish dimensional restoration.

After spraying, thermal treatments may be performed as step 65 as necessary or desirable to cause the separate metal elements within the wear-resistant coating 20, and at the interface between the coating 20 and the substrate 10 and/or the intermediate layer 15, to diffuse as desirable. An exemplary thermal treatment includes one or more processes such as a heat treatment, a hot isostatic pressing treatment, or a sintering treatment such as vacuum sintering, to form the desired alloy or superalloy with a substantially uniform microstructure and composition.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method of forming a wear-resistant coating on a substrate surface, comprising:
cold gas-dynamic spraying a material comprising a rhenium-based composition onto the substrate surface.

2. The method according to claim 1, wherein the substrate surface is formed from an alloy selected from the group consisting of cobalt, molybdenum, tungsten, chromium, magnesium, iron, and nickel-based alloys.

3. The method according to claim 1, wherein the rhenium-based composition is a rhenium-based alloy.

4. The method according to claim 3, wherein the rhenium-based alloy includes at least about 50% rhenium by atomic percent.

5. The method according to claim 3, wherein the rhenium-based alloy comprises at least one element selected from the group consisting of cobalt, chromium, nickel, and manganese.

6. The method according to claim 3, wherein the rhenium-based alloy comprises cobalt, chromium, nickel, and manganese.

7. The method according to claim 3, wherein the rhenium-based alloy comprises by atomic percent about 20% cobalt, about 15% chromium, about 10% nickel, and about 5% manganese.

8. The method according to claim 1, wherein the material comprises a refractory material encapsulated in or mixed with the rhenium-based composition.

9. The method according to claim 7, wherein the material comprises by atomic percent about 15% silicon carbide as the refractory material encapsulated in or mixed with the rhenium-based alloy, and further comprises about 10% cobalt, about 10% chromium, about 10% nickel, and about 5% manganese, the rhenium, cobalt, chromium, nickel, and manganese being elements in the rhenium-based alloy.

10. The method according to claim 1, further comprising:
forming an intermediate metal layer on the substrate surface before cold gas-dynamic spraying the material.

11. The method according to claim 10, wherein the intermediate meal layer comprises a metal that is soluble with both the substrate surface and the wear resistant coating materials.

12. The method according to claim 1, further comprising:
heat treating the cold gas-dynamic sprayed material.

13. A method of forming a wear-resistant coating on a substrate surface, comprising:
forming a metal layer on the substrate surface;
cold gas-dynamic spraying a material comprising a rhenium-based alloy onto the metal layer; and
heat treating the cold gas-dynamic sprayed material.

14. The method according to claim 13, wherein the substrate surface is formed from an alloy selected from the group consisting of cobalt, molybdenum, tungsten, chromium, magnesium, iron, and nickel-based alloys.

15. The method according to claim 13, wherein the rhenium-based alloy includes at least about 50% rhenium by atomic percent.

16. The method according to claim 13, wherein the rhenium-based alloy comprises at least one element selected from the group consisting of cobalt, chromium, nickel, and manganese.

17. The method according to claim 13, wherein the rhenium-based alloy comprises cobalt, chromium, nickel, and manganese.

18. The method according to claim 13, wherein the rhenium-based alloy comprises by atomic percent about 20% cobalt, about 15% chromium, about 10% nickel, and about 5% manganese.

19. The method according to claim 13, wherein the material comprises a refractory material encapsulated in or mixed with the rhenium-based alloy.

20. The method according to claim 19, wherein the material comprises by atomic percent about 15% silicon carbide as the refractory material encapsulated in or mixed with the rhenium-based alloy, and further comprises about 10% cobalt, about 10% chromium, about 10% nickel, and about 5% manganese, the rhenium, cobalt, chromium, nickel, and manganese being elements in the rhenium-based alloy.
